(19) United States
(12) Patent Application Publication
(10) Pub. No.: US 2004/0229965 A1
(43) Pub. Date: Nov. 18, 2004

(54) Method for separating and recovering target polymers and their additives from a material containing polymers

(76) Inventors: Andreas Maurer, Freising (DE); Gerd Wolz, Sarnberg (DE); Martin Schlummer, Ingolstadt (DE); Thomas Luck, Munich (DE); Udo Knauf, Munich (DE); Rolf Kippenhahn, Eschenbach (CH)

Correspondence Address: MARSHALL & MELHORN, FOUR SEAGATE, EIGHT FLOOR, TOLEDO, OH, 43604, US

(21) Appl. No.: 10/786,693

(22) Filed: Feb. 25, 2004

Related U.S. Application Data
(63) Continuation-in-part of application No. 10/344,464, filed on May 22, 2003, now abandoned.
Application No. 10/344,464 is a 371 of international application No. PCT/EP01/06419, filed on Jun. 6, 2001.

(30) Foreign Application Priority Data
Aug. 11, 2000 (DE) 100 39 363

(51) Int. Cl. C08J 11/04

(52) U.S. Cl. 521/40

(57) ABSTRACT

The invention relates to a method for separating target polymers and their additives from a material containing polymers, as a result of which the recovery both of the target polymers and of the additives is made possible. Based on the principle of a selective precipitation, the target polymer is precipitated and subsequently separated from the additives present in solution and dissolved foreign polymers. The separation of the additives from the solution is effected in a further step.

The subject of the invention is a method for separating and recovering target polymers and their additives from a material containing polymers, with which processing both of the target polymers and of the additives is made possible.

Plastic materials or materials containing plastics are used in various ways for the production of short-lived economic goods and represent thereby a serious waste problem. This can be attributed to the fact that separation of the polymers and of the additives has been able to date to be implemented only to a limited degree. In this connection, material recycling methods which enable the production of new raw materials from the reprocessed materials are gaining ever greater importance.

An example of this is represented by the processing of plastic waste containing bromine, bromine compounds being added to the polymers as fireproofing additives.

According to current estimates, an amount of 226,000 t plastic material is contained in European electronics scrap, of which 105,000 t of plastic scrap containing bromine can be separated by suitable sorting methods (European Economic Service, November 1999).

This separation is required at the moment since, according to the current state of the art, bromine-free plastic scrap is amenable to material recycling but in contrast bromine-containing plastic scrap is excluded from material recovery because of possible exceeding of the threshold value of polybrominated dibenzo-p-dioxins and -furanes (PBDD/F) in the recyclate.

PBDD/F arise during thermal stressing of various aromatic brominated fireproofing agents (English “flame retardant”, FR), for example during improper production of the flame retardants, during compounding or renewed extrusion during recycling and therefore are detectable both in used plastic materials and in plastic material recyclates (RIESS et al., BayFORREST research project F116, 1998).

The various brominated flame retardant additives have a very varied PBDD/F formation potential. The finishing with tetrabromobisphenol A (TBBP A) in which the bridging oxygen between the aromatic ring has been replaced by a blocking alkyl group, leads to only a small formation of PBDD/F. The usability of this flame retardant corresponding to the state of the art and of the new polymers and plastic material recyclates which are flame-retarded in this manner is generally not impaired. On the other hand there exists according to current knowledge the danger of a quantitatively relevant PBDD/F formation when using flame retardants which are structurally similar to PBDD/F, such as for example polybrominated diphenylether (PBDE), polybrominated biphenyls (PBB), bis-[dibromopropoxy-dibromophenyl]-propane (OBPE) or bis-(tribromo-phenoxy)-ethane (TBPE).

Because of the large proportion of the above-mentioned polybrominated flame retardants with high dioxin formation potential, a low chance of success is attached currently to the material recovery of used plastic materials which are flame-retarded with bromine and this plastic material fraction is dumped in practice or thermally treated.

In order to solve this disposal problem, the attempt has been made therefore to extract bromine before renewed extrusion by means of supercritical CO₂ (Marioth et al. 1996) or to remove it by reduction of the brominated compounds (von Quast, 1998). These approaches were in fact successful in the laboratory but have proved not to be profitable or they had in addition the disadvantage that the recyclate in comparison to used plastic material lost its flame-retardant finish so that both method approaches have not been applied to date on a larger scale.

Admittedly, used plastic materials finished with brominated flame retardants involve the potential for the recovery of the contained bromine. According to a report of the European Brominated Flame Retardant Industry Panel (EBFRIP), the potentially available quantity of bromine from electrical and electronics scrap corresponds approximately to 10,000 t. The possibility of returning this bromine quantity into the industrial bromine cycle appears therefore to be promising both with respect to saving of resources and from an economic point of view.

A recycling method for selective extraction from various commercial plastic materials is described in DE 197 32 673 A1. With this method, individual plastic material fractions are selectively extracted from non-homogeneous used plastic material mixtures, the polymer extract is cleaned, the interfering substances are reduced and the polymer is finally precipitated.

A further example of the reprocessing of materials containing plastic materials is the recycling of polyvinyl butyral (PVB) scrap from automotive vehicle windscreens. Composite glass panes which stem predominantly from automobile construction have already been recycled for many years by glass recoverers. These panes have a plastic material central layer made of high quality soft PVB film as protection against shattering. The PVB films occurring as a residue during glass recycling are contaminated with abrasive glass, wood, latex, silicone and adhering metals from the window glass processing. They are therefore dumped or supplied to a small extent for thermal usage in cement works, the achievable proceeds not covering the costs of the required pre-treatment (glass separation).

A material recovery of uncleaned PVB in paints and bitumen (EP 0 582 219 B1) appears theoretically possible but is not operated commercially.

The removal of the various PVB plasticisers which, in addition to improved transportability and storability, also represent the basis for products with defined properties, is unconditionally required. However, the industrial working group of PVB film producers and raw material suppliers rejected plasticiser separation at the beginning of the 90's for economic reasons. The method described is DE 197 32 673 A1 offers the possibility of recovering, by optimised cleaning and precipitation from mixed contaminated plastic scrap occurring in composite construction, high quality recyclates which are low in plasticisers for use in the original application.

Admittedly, this method has the disadvantages that neither can the additives be recovered nor is the efficiency of the cleaning of the polymer high enough, so that an economic incentive is not offered for commercial application in the processing of plastic material-containing scrap in this form. A higher cleaning efficiency of this method could only be produced by additional cleaning steps of the polymer solution which in turn represents however a considerable energy and cost factor.

It is therefore the object of the present invention to make available a method with which separation of the target polymer and of the additives from a material containing polymers is made possible. It is an objective thereby to reprocess both the target polymer and the additives in such a manner that re-use of these components is made possible. The high claims required for this purpose with respect to efficiency of the cleaning of the components is intended to be ensured by a method which, based on the principle of a selective precipitation, isolates both the polymer and the additives with great purity.

The invention is achieved by the characterising features of patent claim 1. The use of the method is indicated in claim 25. The sub-claims represent preferred embodiments and developments.

The method for separating and recovering target polymers and their additives is based on the fact that the target polymer together with the additives is dissolved initially in a solvent I. This solution is placed with a non-aqueous solution II, which is miscible with the solvent I, the target polymer not dissolving in said solvent II, as a result of which the target polymer is precipitated, whilst the additives continue to remain in dissolved form. The precipitated target polymer is subsequently separated from the solution just as the additives.

As a variant, the separation of a target polymer from a polymer mixture is effected in which further foreign polymers are contained, at least one foreign polymer being dissolved also in the solvent I and, during precipitation of the target polymer, the dissolved foreign polymers not being precipitated also.

As a further variant, a solvent system comprising water and a solvent III, which is not miscible with water, can be used instead of a solvent II in step b). The target polymer is hereby then precipitated in the phase which is formed by means of the solvent III.

The type of placing is now effected such that the target polymer dissolved in solvent I together with the additives is placed in the solvent II or, in the case of the second variant, in the solvent system comprising water and a solvent III. The placing of the dissolved target polymer is thereby effected advantageously by means of a nozzle which is immersed just below the liquid level.

In an advantageous development, the solvent II or the solvent system comprising water and a solvent III can be placed also in the solvent I in which target polymer and additives are present in a dissolved state.

In the case of the variant of the solvent system comprising water and a solvent III which is not miscible with water, the possibility exists in addition of mixing the target polymer dissolved in solvent I with the solvent III and subsequently of producing the formation of two phases by adding water.

The method presents itself in a preferable manner for the target polymers polyvinylchlorides (PVC), polycarbonates (PC), polystyrenes and copolymers thereof, e.g. polyacrylonitrile-butadiene-styrene (ABS), polyacrylates, polymethacrylates, polyethyleneterephthalates (PET) and polyvinyl butyrals (PVB).

As additives, preferably polybrominated diphenylethers (PBDE), polybrominated biphenyls (PBB) bis-[dibromopropoxy-dibromophenyl]-propane (OBPE) or bis-(tribromophenoxy)-ethane (TBPE) can be separated and processed. Likewise, the separation of plasticisers, such as for example esters of phthalic acid or adipinic acid, aliphatic carboxylic acids (C₄-C₈) or polyethylene glycol, is made possible from plastic materials.

For the solution of the polymers there are presented advantageously as solvent I low molecular alcohols (C₁-C₅), cyclic ethers such as tetrahydrofurane (THF), aliphatic ketones such as acetone or methylethylketone, cyclic ketones such as cyclohexanon and cyclopentanon and basic ester mixtures such as DBE or mixtures of these solvents. For the solvent II there is used preferably a low molecular alcohol (C₁-C₅) whilst for solvent III a non-polar aliphatic or aromatic hydrocarbon such as n-hexane can be used.

Before method step b), a separation of components which are not soluble in solvent I can be effected. There are included herein above all foreign polymers or decomposition products occurring in the plastic material or in the material containing plastic material. This step is effected preferably with physical separation methods, such as for example filtration via a metal gauze filter.

The separation of the precipitated target polymer from the solution is effected according to physical separation principles. Thus the target polymer precipitated from the solution can thus be decanted in a centrifuge or be filtered.

After separation of the precipitated target polymer, its drying is effected, this being implemented preferably at temperatures above 50° C. The dried target polymer can then be extruded again subsequently with the extruders from the state of the art.

For the separation and recovery of the additives, the solution containing the additives is advantageously distilled. Likewise, membrane separation methods or chromatographic separation methods, such as are known from ion-, partition- and adsorption-chromatography, can also be used.

If the method for the separation and recovery of halogen-containing flame retardants is used, the recovery of the halogens is achieved in a preferred manner by a reduction of the flame retardant.

The method for separating and/or recovering target polymers from their additives comprising materials containing polymers is used mainly in the reprocessing of plastic materials and plastic material-containing materials which contain halogens.

The reprocessing of plastic materials or plastic material-containing materials which contain plasticisers also represents a preferred field of use. There is included hereby as a preferred example the processing of polyvinylbutyral (PVB) scrap which can be separated from the plasticisers-additives with this method. These plastic materials are used above all in the production of the composite glass panes for automobile construction.

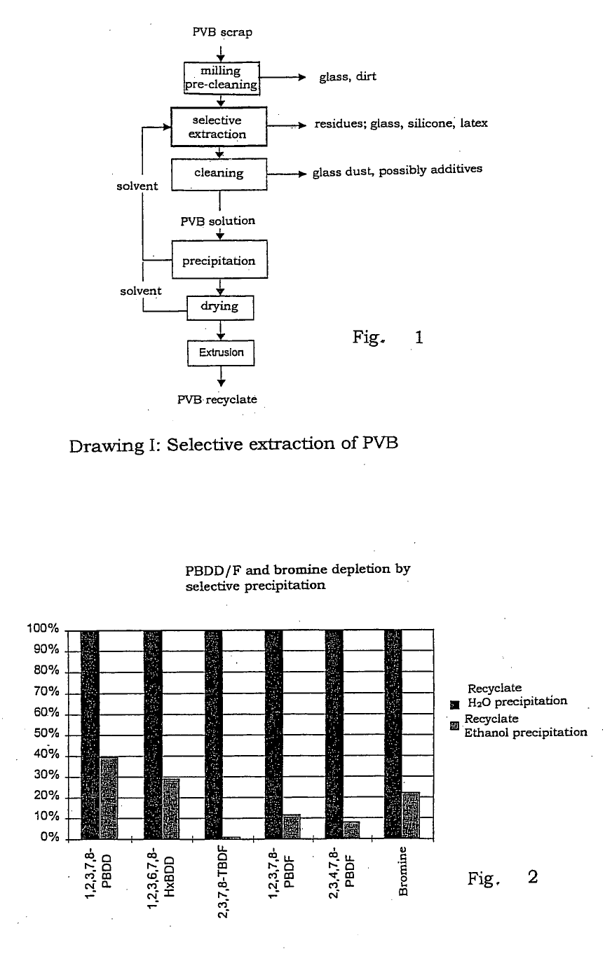

Further advantages and embodiments are represented in FIG. 1 and in the subsequent embodiments.

FIG. 1 represents the diagram according to the invention of the course of the method for the reprocessing of polyvinylbutyral (PVB) scrap. Here, all the method steps from untreated plastic material scrap up to cleaned plastic material recyclate are demonstrated.

### EXAMPLE 1

Approximately 500 g darkly coloured plastic material parts were manually sorted out from a shredded electronics scrap sample since flame-retardant electronic housing parts frequently have this colouration. This mixed sample was ground with a cutting mill to a particle size of approximately 2 mm.

The mixed sample was divided into three and each third was examined twice by means of RFA for the total bromine content. The average value of all the measurements was at 1.09% bromine in the sample, no significant difference having been able to be established with respect to the bromine content between the thirds.

In the case of the PBDD/F analysis of the plastic material scrap, non-2,3,7,8-brominated (and hence not listed in the ChemVV [chemical prohibition regulation]) tetra- and pentadioxins and -furanes were identified in concentrations up to 100 ppm. The sums of the congeners cited in the ChemVV were at 0.29 (sum 4, threshold value 1 ppb) and 0.49 (sum 4+5, threshold value 5 ppb) below the threshold values of this regulation.

300 g of the mixed sample were put into 2.7 kg (3.4 l) acetone and the batch was initially agitated with agitator mixing then with a blade agitator. After 20 hours there still remained a large swollen residue in the batch which finally was neglected. The remainder was filtered via a metal gauze filter and weighed. 1.8 kg polymer solution with a dry substance component of 6.46% was thus able to be recovered. The recovered solution was divided into two equal portions of 900 g.

The precipitation was effected by drop-wise addition of the solution into a highly agitated receiving flask with water (4.5 kg tap water) or ethanol (4.5 kg universal solvent: ethanol/acetone 95/5).

The flaky precipitate was finally dried in a drying cupboard at 70° C. The yield of the precipitate precipitated with water is 55.5 g (=97% relative to the quantity of polymer in solution), that of the ethanol precipitate 49.9 g (=86%).

The original electronics scrap and both reprecipitated products were re-extruded on a twin screw extruder.

The separation of polybrominated dibenzo-p-dioxins and dibenzofuranes and also of the total bromine achievable by means of the method were convincing in the case of the selective ethanol precipitation, in the case of the non-selective precipitation in water they were marginal (see FIG. 2).

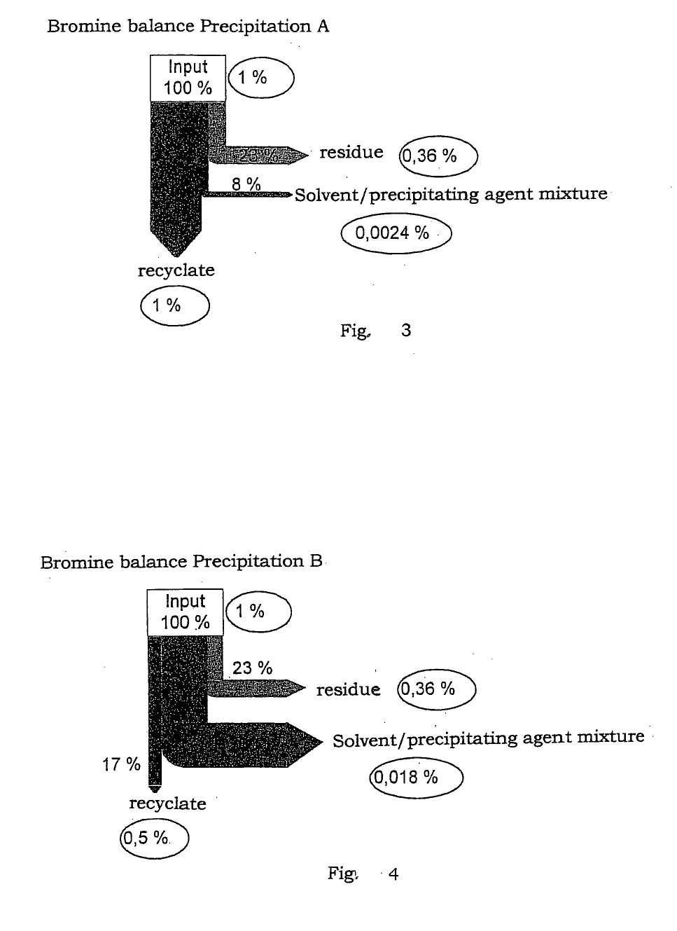

A material balance for water (see FIG. 3) and ethanol (see FIG. 4) can be comparatively represented with the material flows and the detected concentrations occurring here.

### EXAMPLE 2

Production of ABS Recyclate (Dissolving and Precipitation of ABS-Containing Electronics Scrap)

1. Dissolving with Acetone, Cleaning

At a temperature of approximately 50° C., 700 g acetone were placed in the dissolving container and heated with constant agitation to the corresponding temperature. During the entire heating and dissolving process, the cooling system operated in order to return evaporating acetone once again into the dissolving container.

When the acetone had reached the solubility temperature, the ABS-containing electronics scrap (m =300 g) was added slowly. After completion of the dissolving process after 30 minutes, the remainder of the solution was poured off. In order to obtain as clean an ABS solution as possible without impurities, the poured-off remainder (approximately 650 ml) was filtered in the one layer filter over a filter gauze with a mesh width of 63 μm.

Thereafter, the filtrate was cleaned still further via a disposable filter with a 0.8 μm pore size. The thus obtained, twice filtered solution had a TS content of approximately 16%.

2. Precipitation in Ethanol

Approximately 250 ml of the ABS solution were precipitated by spraying in ethanol. For this purpose, a plastic box was filled with ethanol (level 4.5 cm, corresponding approximately to 6.75 l) and the polymer solution was sprayed in just below the liquid level. The precipitated ABS was separated from the ethanol by sieving and subsequently was dried overnight in the drying cupboard at 55° C. During the drying, the liquid (solvent-/precipitating agent mixture) was withdrawn from the plastic material and was decanted after approximately 2 hours drying time. This means that it is possible to withdraw the greater part of the adhering liquid from the precipitated ABS in that the moist product is heated after precipitation and the depositing liquid is poured off.

At the end of the drying, 25 g dry product (ABS recyclate) were obtained.

### EXAMPLE 3

Plasticiser Separation from Soft PVC

1. Precipitation

It is the object of the precipitation to recover the PVC in the form of particles which can be separated as easily as possible. This occurs by reduction of the solubility of the PVC in the solution, for example by addition of a precipitating agent. Ethanol and hexane were used as precipitating agents.

It is important during the precipitation that substances which are already present separately—in particular plasticisers—are not again included in the PVC matrix but remain dissolved in the liquid phase: principle of selective precipitation.

a) Ethanol

Ethanol was used in order to precipitate PVC solutions in THF and in amylacetate-xylene.

500 g of a 10% PVC solution in THF were mixed with 740 g ethanol. The addition was effected with a volume flow of 40.67 ml/min. After 20 minutes, a paste of fine PVC flakes was observed. The flakes do not bond into larger flakes but are deposited on the container base.

Solutions in amylacetate-xylene were precipitated by addition of ethanol in particle formations with a size of approximately 15 mm.

b) Hexane

Exclusively PVC solutions in THF were precipitated with hexane in order to examine the reduction in plasticisers.

Particle formations with a size of approximately 15 mm were produced during the slow precipitation.

2. Cleaning Effectiveness

During the analytical evaluation of the starter material, plasticisers were essentially established as interfering materials in addition to the mechanically separable filler chalk. The most important representative with respect to quantity is benzylbutylphthalate (BBPh). In order to evaluate the cleaning effectiveness with respect to additives, the content of BBPh was therefore examined before and after recycling with various solvents and precipitating agents and also precipitating methods.

2.1% benzylbutylphthalate (BBPh) were established in the starter material AGPR1.

a) Ethanol

Significantly lower BBPh contents were able to be achieved in the case of precipitations with ethanol. In the case of solutions in THF, contents of 0.64% were measured, in the case of solutions in amylacetate-xylene (1:1) of 0.73%. This corresponds to a reduction of 95%.

The addition of the precipitating agent can be effected in several stages. As a first stage, 15 kg PVC-THF solution (10% PVC) were diluted with 15 kg ethanol in an 80 l reactor. During this method step, still no PVC particles were precipitated. The subsequent dosing of the solution in the same quantity of ethanol (PVC-THF-ethanol solution: ethanol =1:1) led within one minute to the precipitation of the PVC particles in a uniform form. During addition, the presented ethanol was constantly agitated so that a good mixture of solution and precipitating agent was able to be achieved.

The bulk density of the pulverulent PVC recyclate achieved with this method is 0.1 g/cm³. It has a good pourable structure and can therefore be taken in directly by an extruder.

b) Hexane

During a precipitation with hexane, values up to 1.5% BBPh for solutions in THF were able to be achieved, i.e. a reduction of 90%.

It is striking altogether that, independently of the solvent and of the precipitation method, solely the precipitating agent is decisive for the achievable reduction of the contained plasticisers. Any plasticisers not dissolved in the solvent-precipitating agent mixture remain bonded to the PVC matrix and are also precipitated.

### EXAMPLE 4

Decolouration of Unsorted PET Scrap by Selective Precipitation

The shredded PET fraction of DSD scrap was selected as test material. In addition to faulty ejections of other polymers, this includes external contaminants, metal and paper residues. In addition, approximately 30% of the flakes are differently coloured (green, blue, yellow, red, brown). From the unsorted scrap mixture, firstly uncoloured flakes (sample A, “best-case” material) and then only coloured flakes (sample B) were sorted as “worst case” material. Sample C produced unsorted flakes.

10% DBE solutions of these samples were produced by addition of the flakes in boiling DBE. After complete dissolving of the PET components in the scrap, the samples were precipitated in various precipitating agents: Sample A in water, samples B and C in ethanol. 200 to 300 ml polymer solution were added thereto into highly turbulently agitated precipitating agent and thus precipitated. The precipitates were dried for two hours at 100° C. in the drying cupboard. (Compressed films are produced from all three precipitates).

The precipitated recyclates (the above-mentioned precipitates) were evaluated with respect to discolouration in that they were assigned to the following RAL cards (RAL-K7, colour overview).

Sample A: RAL 1015 (Light ivory)

Sample B: RAL 9001 (Creamy white)

Sample C: RAL 9003 (Signal white)

### EXAMPLE 5

Precipitation of the Ethanolic PVB Solution in a 2-Phase System n-Hexane/Water

This test was implemented both on a small scale in the laboratory and also with a larger quantity. The PVB samples dissolved in isopropanol (approximately 40° C.) (unwashed PVB scrap directly from the dump) were poured during constant, slow agitation into a beaker glass filled with water/n-hexane. Care was taken that the n-hexane phase does not mix with the water phase and that the polymer solution remains as long as possible in the n-hexane phase.

With the large batch, approximately 450 g PVB scrap were removed from the barrel and dissolved in approximately 10 litre butanol/ethanol/isopropanol in heat and with constant agitation. Subsequently, the polymer solution is first filtered via a 500 litre/min filter and subsequently via a 150 litre/min filter. Because of the large proportions of contaminants, a gel-like contaminated sediment is formed. The filtered approximately 7.5 litre polymer solution (brown-coloured and optically opaque) are precipitated. The precipitation of respectively 1 litre polymer solution in 2 litre n-hexane is effected above the lower phase (6 litre water). The water and the n-hexane is renewed after each precipitaton. The PVB deposit is dried at 90° C. and subsequently ground in a mill cooled with nitrogen.

In the case of this variant, a good plasticiser separation is achieved (comparable with an 8 hour Soxhlet extraction).

### EXAMPLE 6

Mixing of the PVB Solution with Hexane and Subsequent Precipitation Test of the PVB with Water

For liquid-liquid extraction of plasticisers by means of hexane from the ethanolic PVB solution, 10% n-hexane is added slowly during agitation. The precipitation of the PVB and subsequent phase separation (displacement of the n-hexane and of the plasticisers from the homogeneous solution) should be effected by addition of 10% water. As a result, a stable emulsion is obtained after water addition and thorough mixing. The incomplete phase separation is effected very slowly over several hours: a gel-like emulsion phase is formed above, a clearer PVB solution below.

With ethanol solutions which contain 10% water, unstable emulsions are achieved in contrast with unchanged good dissolving properties after addition of n-hexane and very thorough mixing, said emulsions separating into two phases within 10 minutes.

The above observed kinetic restricted phase separation of an n-hexane-ethanol-water-PVB solution can be achieved in this manner. The cleaning effect of a liquid-liquid extraction with n-hexane is particularly promising, the plasticiser reduction corresponds at least to the 8 hour Soxhlet extraction.

1-27 (deleted)

28. A method for separating and recovering target polymers and their additives from a material containing polymers, comprising:
a) the target polymer together with at least one additive is dissolved in a solvent I;
b) the dissolvent target polymer with the at least one additive is mixed with a first part of a non-aqueous solvent II, which is miscible with the solvent I, the target polymer is precipitated while the at least one additive remains in dissolved form; and
c) the precipitated target polymer and
d) at least one additive present in liquid phase are separated; wherein the addition of the non-aqueous solvent II is effected in several stages.

29. The method according to claim 28, wherein the polymer-containing material contains a polymer mixture; at least one further foreign polymer is dissolved in addition to the target polymer in step a); and the foreign polymers remain in dissolved form.

30. The method according to claim 28, wherein the solvent mixture from b) is introduced with a nozzle.

31. The method according to claim 28, wherein, as the target polymer, a polymer from the group of polyvinylchlorides, polycarbonates, polystyrenes and copolymers thereof, polyacrylates, polymethacrylates, polyethyleneterephthalates and polyvinyl butyrals is separated.

32. The method according to claim 28, wherein, as additives, halogen-containing flame retardants are separated and processed.

33. The method according to claim 28, wherein, as additives, plasticisers are separated with polyethylene glycol and processed.

34. The method according to claim 28, wherein the solvent I is selected from the group of the low molecular weight alcohols (C₁-C₅), of the cyclic ethers, of the aliphatic and cyclic ketones, basic ester mixtures or a mixture of these.

35. The method according to claim 28, wherein the solvent II is a low molecular weight alcohol (C₁-C₅).

36. The method according to claim 28, wherein, before step b), the target polymer dissolved in solvent I is separated from the non-soluble components in solvent I by physical separation methods.

37. The method according to claim 36, wherein the physical separation method comprises filtration.

38. The method according to claim 28, wherein the precipitated target polymer is isolated by a physical separation method.

39. The method according to claim 28, wherein the precipitated target polymer is decanted and/or filtered off.

40. The method according to claim 28, wherein the target polymer is dried after the separation.

41. The method according to claim 40, wherein the drying is implemented at a temperature of more than 50° C.

42. The method according to claim 28, wherein the separated and dried target polymer is re-extruded.

43. The method according to claim 28, wherein the additives are recovered by distillation of the solution in step d).

44. The method according to claim 28, wherein, in step d), the additives present in solution are recovered by chromatographic separation methods.

45. The method according to claim 28, wherein, in step d), the additives present in solution are recovered by membrane separation methods.

46. The method according to claim 28, wherein, in step d), the halogens are recovered from the halogen-containing additives present in solution by reduction of the flame retardants.

47. The method according to claim 28, wherein the material containing polymers comprises plastic materials and/or plastic material containing materials which contain halogens.

48. The method according to claim 28, wherein the material containing polymers comprises plastic materials and/or plastic material containing materials which contain plasticisers.

49. The method according to claim 28, wherein the material containing polymer comprises material containing polyvinyl butyral the method further comprising forming the processed material into one of:
flat glass;
implosion and explosion protection materials for laboratory glass; and
soundproofing composite metal sheets or polymer coatings for sintered porous glass plates and shapes.

50. The method according to claim 33, wherein the plasticisers comprise at least one of pthalic acid, adipinic acid and aliphatic carboxylic acids (C₇-C₈).

51. The method according to claim 44, wherein the chromatographic separation method comprises one of ion-partition and adsorption chromatography.

52. The method according to claim 32 wherein the halogenated flame retardants are selected from the group consisting of: polybrominated diphenylether (PBDE), polybrominated biphenyls (PBB), bis-(dibromopropoxy-dibromophenyl)-propane (OBPE) or bis-(tribromo-phenoxy)-ethane (TBPE)
